(19) United States
(12) Patent Application Publication
(10) Pub. No.: US 2002/0135258 A1
(43) Pub. Date: Sep. 26, 2002

(54) Laminated rotor for eddy-current brake and device including such a rotor

(76) Inventors: Daniel Drecq, Saint Leger en Yvelines (FR); Antoine Lesobre, Boulogne (FR)

Correspondence Address: YOUNG & THOMPSON, 745 SOUTH 23RD STREET 2ND FLOOR, ARLINGTON, VA, 22202

(21) Appl. No.: 09/908,745

(22) Filed: Jul. 20, 2001

(30) Foreign Application Priority Data
Jul. 20, 2000 (FR) 00 09514

(51) Int. Cl. H02K 1/00

(52) U.S. Cl. 310/216

(57) ABSTRACT

This laminated rotor for an eddy-current braking device includes a stack (1) of flat elements (2) parallel to each other, made of ferromagnetic material, the said stack being bounded in the direction perpendicular to the said flat elements (2) by two opposite surfaces (5), as well as at least one housing through the thickness of the said stack for accommodating a ferromagnetic component (8) made of ferromagnetic material which is solid or laminated in another direction than the said stack (1), able to establish a magnetic bridge extending between the said two opposite surfaces (5) and/or to hold the said flat elements assembled.

The present invention relates to a laminated rotor for an eddy-current braking device or a device having a function of eddy-current brake and a function of variable-reluctance motor.

It is reiterated that an eddy-current braking device includes a ferromagnetic rotor which is immersed in a magnetic field parallel to its axis of rotation. The toothed structure of the rotor creates a variation in magnetic induction. This variation induces currents in the ferromagnetic parts of the stator facing the rotor, and the power of the braking device is equal to the power dissipated by Joule effect. The effectiveness of the braking therefore depends on the value of the variation in induction which itself depends on the ferromagnetic properties of the material from which the rotor is produced. A rotor made of solid ferromagnetic material makes it possible to obtain very high effectiveness. Such a solid rotor, obtained by casting or machining from the solid, is markedly more expensive than a rotor produced from laminated ferromagnetic material. However, a laminated rotor is less effective for eddy-current braking, and the magnetic braking force exerts stresses which separate the elements of its laminated structure and cause it to deteriorate.

In order to compensate for this loss of effectiveness when a laminated rotor is used, it is possible to increase the amplitude of the magnetic induction field by increasing the strength of current feeding the inductors of the device. However, such an increase in the current, in addition to its costs, exhibits the disadvantage of increasing the stresses which separate the laminated structure and of accelerating the deterioration of the rotor. It would therefore be beneficial to find a means of making the structure of a laminated rotor resistant to these stresses, so as to be able to subject it to more intense fields. The object of the present invention is to provide such a laminated rotor resisting the magnetic braking force for an eddy-current braking device with, moreover, enhanced braking effectiveness.

Furthermore, in addition to their reduced cost, laminated rotors are of great benefit in variable-reluctance motors. This is because, in a variable-reluctance motor, a toothed rotor made of ferromagnetic material is immersed in a radial magnetic field the direction of which is variable in angle. The presence of a variable magnetic field also induces eddy currents in the rotor of such a device. However, in the case of the variable-reluctance motor, the presence of eddy currents is a parasitic phenomenon which reduces the effectiveness of the motor and causes heating of the rotor; it is therefore necessary to minimize it as far as possible. This is because these eddy-current losses are detrimental both to the efficiency of the motor and to its performance, and degrade the rotor due to locally generated heating.

To this end, the use of a laminated rotor, and more particularly of a laminated rotor including a stack of elements of ferromagnetic sheet metal covered by a layer of electrical insulant, makes it possible to reduce the power dissipated by the eddy currents and exhibits an effectiveness enhanced by more than about 100% by comparison with a solid ferromagnetic rotor. This enhancement in the effectiveness of the laminated rotor is due to an increase in the electromagnetic forces and to a reduction of the losses, both a consequence of the increase of the average resistivity of the rotor by comparison with the solid material.

In summary, a solid rotor constitutes the best solution for eddy-current brakes, and a laminated rotor the best solution for variable-reluctance motors. Hence, when it is desired to combine the functions of eddy-current brake and of variable-reluctance motor into a single rotor, a compromise has to be found in order to limit the losses generated by the eddy currents when the rotor is used for the motor function, and, on the contrary, to optimize the magnetic flux which passes through the rotor (in the direction of the axis of rotation) when the braking function is being used. A laminated rotor promotes the passage of the radial magnetic fluxes but impedes the circulation of the axial magnetic fluxes used in the braking mode. The axial magnetic flux then has to pass through as many small gaps as there are spaces between the metal plates. Moreover, the use of a laminated material appreciably reduces the cost of the rotor. The object of the invention is also to provide a variable-reluctance motor laminated rotor able to be used as a means for eddy-current braking and the effectiveness of which is enhanced by comparison with a simple laminated rotor, as well as a device having a function of eddy-current brake and a function of variable-reluctance motor including such a rotor.

To that end the present invention provides a laminated rotor for an eddy-current braking device including a stack of flat elements parallel to each other, made of ferromagnetic material, the said stack being bounded in the direction perpendicular to the said flat elements by two opposite surfaces, characterized in that it includes at least one housing through the thickness of the said stack for accommodating a ferromagnetic component, made of ferromagnetic material which is solid or laminated in another direction than the said stack, able to establish a magnetic bridge extending between the said two opposite surfaces and/or to hold the said flat elements assembled.

Advantageously, each ferromagnetic component includes two ends linked respectively to each of the said two opposite surfaces, in such a way as to keep the said flat elements in contact against one another.

Preferably, in this case, each ferromagnetic component is electrically insulated from the said stack, except possibly in the vicinity of the said two linked ends.

Preferably, each ferromagnetic component includes a pin, of any shape, extending through the said flat elements substantially perpendicularly to them.

Advantageously, each pin is welded at its ends to the said two opposite surfaces.

According to a particular characteristic of the invention, the said stack comprises a cylindrical central part in which an axial hole is pierced, substantially perpendicularly to the said flat elements, in order to allow the said rotor to be mounted on an axis of rotation.

Advantageously, the central part of the said stack includes several pins arranged over one or more circle(s) centered on the said axis of rotation.

In one particular embodiment, the rotor according to the invention is also able to serve as rotor of a variable-reluctance motor, the said stack comprising a plurality of teeth cut out in the said flat elements and extending substantially radially with respect to the said axis of rotation from a substantially cylindrical central part.

Preferably, in this case, the majority of the teeth each include at least one of the said pins.

Advantageously, each tooth includes several of the said pins radially spaced from one another.

Advantageously, each pin is arranged on a median radial axis of the associated tooth.

According to another characteristic of the invention, at least one first sub-set of the said stack includes the said teeth cut out over a first predetermined radial distance from the periphery of the flat elements, and at least one second sub-set of the said stack includes the said teeth cut out over a second predetermined radial distance greater than the said first radial distance, in such a way that the said first sub-set defines a plurality of webs between the teeth of the second sub-set.

Advantageously, the said first sub-set is in the middle of the stack and includes, on either side of its median plane, a sub-set of the type of the abovementioned second sub-set.

Preferably, each flat element is covered on its two opposite flat faces by a layer of electrical insulant.

The invention also provides an eddy-current braking device characterized in that it comprises a laminated rotor having one or more of the characteristics described above, integral with a shaft mounted rotating through a casing containing at least one induction coil carried by an inner peripheral region of the said casing, in order to generate a magnetic field through the said rotor, the said field being able to generate eddy currents so as to brake the rotation of the shaft.

Advantageously, the braking device further includes a plurality of induction coils with substantially radial axes and spaced at angles over the inner periphery of the casing, the said radial coils being able to be fed sequentially so as to drive the teeth of the rotor in rotation by the action of a substantially radial magnetic field of variable angular direction, so that the device can also serve as a variable-reluctance motor.

Preferably, the casing includes heat exchangers axially spaced from the opposite surfaces of the rotor by a gap, in such a way that the said ferromagnetic components serving as magnetic bridges are positioned face-to-face with the said heat exchangers.

The invention will be better understood, and other objects, details, characteristics and advantages thereof will emerge more clearly in the course of the following description of several particular embodiments of the invention, given solely by way of illustration and non-limiting, by reference to the attached drawing. In this drawing:

FIG. 1 is a view in perspective of the rotor according to the invention in a first embodiment;

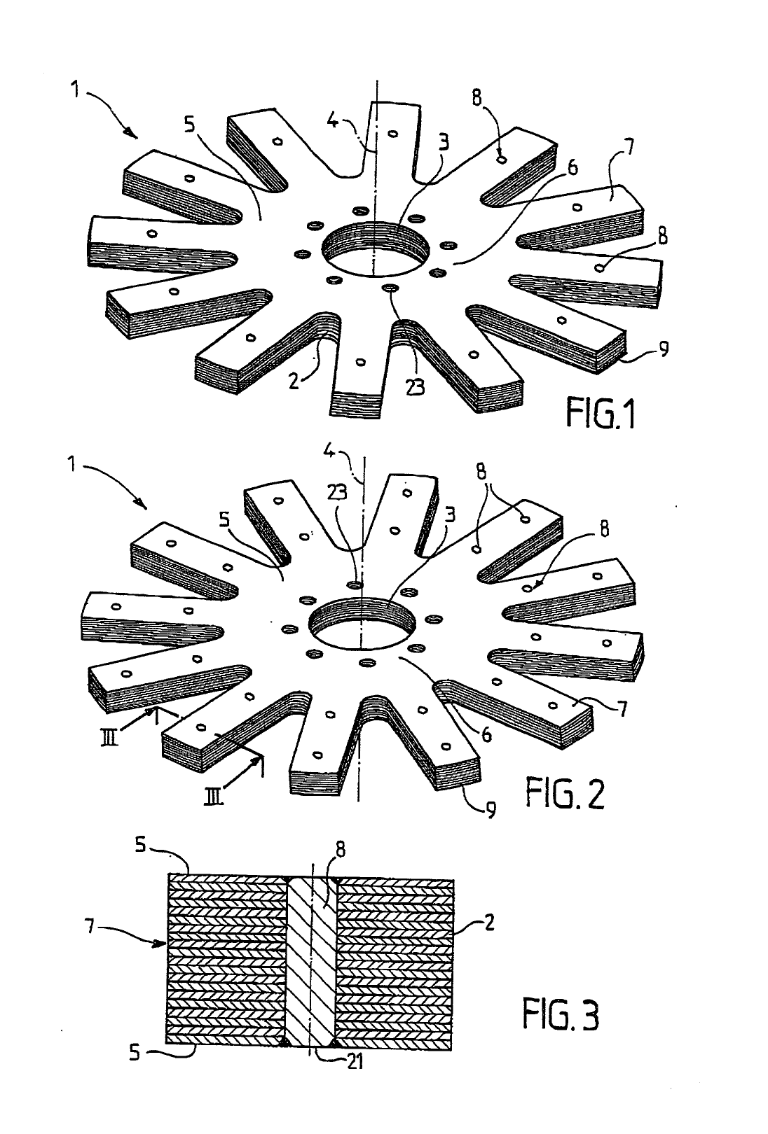

FIG. 2 is a view in perspective of the rotor according to the invention in a second embodiment;

FIG. 3 is a sectional view of one tooth of the rotor according to the invention along the line III-III of FIG. 2;

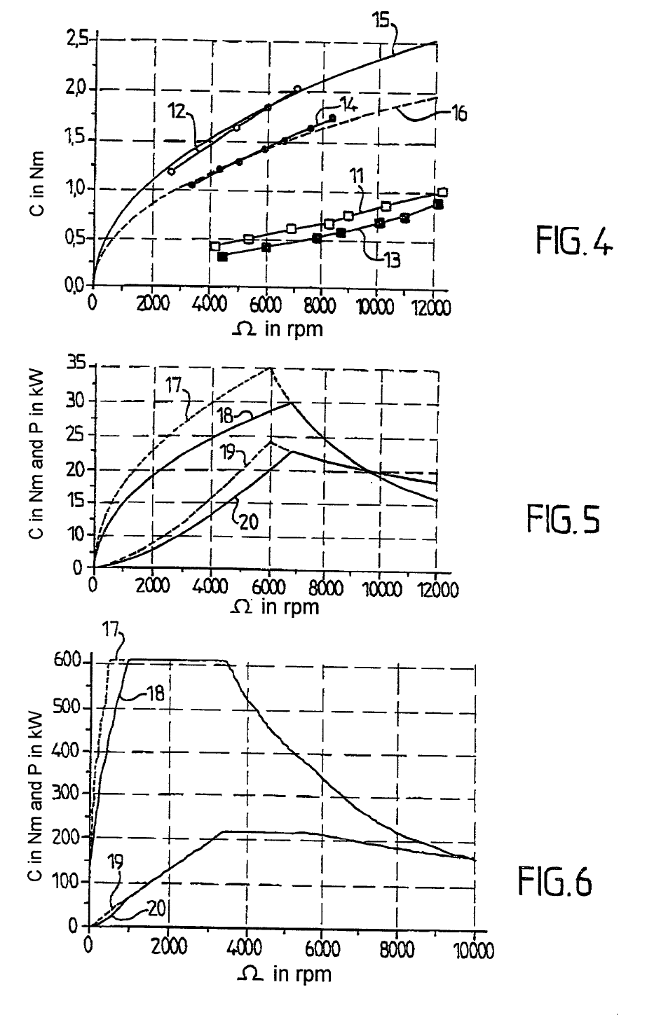

FIG. 4 is a graphical representation of the braking torque of an eddy-current brake as a function of the rotational speed of the rotor, for rotors produced from different materials and for different values of the current strength in the induction coils;

FIG. 5 is a graphical representation of the torque and of the braking power of an eddy-current brake as a function of the rotational speed of the rotor, for rotors produced from different materials;

FIG. 6 is a graphical representation similar to that of FIG. 5 for a higher-power device;

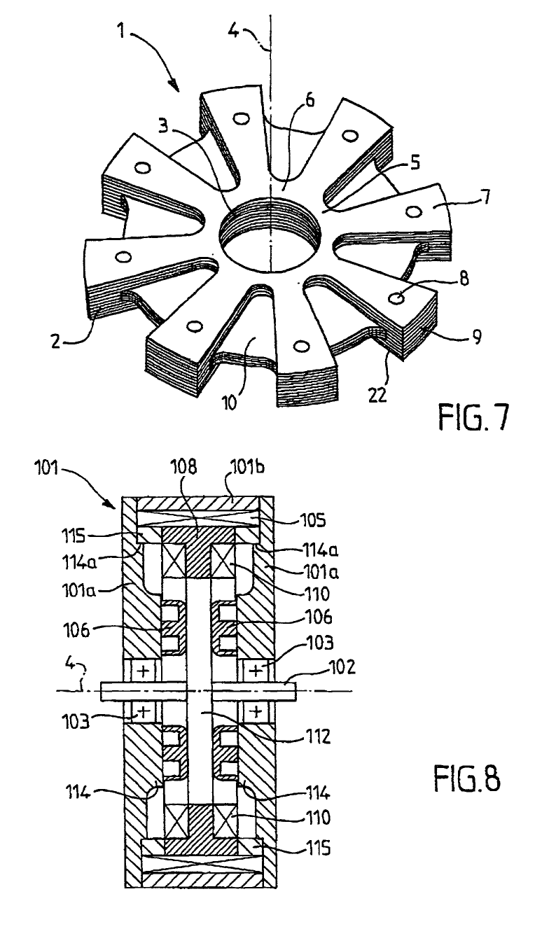

FIG. 7 is a view in perspective of a third embodiment of the rotor according to the invention;

FIG. 8 is a sectional view of a device having an eddy-current braking function and a variable-reluctance motor function.

The subject of the invention is a laminated rotor intended to be mounted on an axis of rotation of an eddy-current braking device or of a device having an eddy-current braking function and a variable-reluctance motor function. The functioning of such devices is described in the French Patent Application No 9905452. An eddy-current brake machine typically includes a ferromagnetic rotor mounted so as to rotate on an axis in a casing carrying an induction coil coaxial with the rotor so as to produce a magnetic field. The casing also carries heat exchangers, facing the rotor, for removing the heat generated on the surface of these exchangers by Joule effect in the course of the braking. The rotor of such a machine has to be toothed so as to generate a variation in magnetic induction at the surface of the heat exchangers made of solid, conducting ferromagnetic material.

A variable-reluctance motor includes a ferromagnetic rotor toothed at regular angles, and a stator which surrounds the circumference of the said rotor and carries induction coils with substantially radial axes spaced at regular angles. The operating principle of the motor consists in sequentially feeding these radial coils so as to align the teeth of the rotor along a time-variable axis, which drives the rotation of the said rotor. In a device carrying out both the functions of eddy-current brake and of variable-reluctance motor, the braking coil, the stator with the motor coils and the heat exchangers are arranged in successive crown rings in order to limit the size of the device.

As can be seen in FIGS. 1 and 2, the rotor according to the invention comprises a body 1 made of laminated ferromagnetic material, that is to say a stack of sheet-metal elements 2 made of ferromagnetic material, parallel to each other, cut out according to the desired shape. The sheet-metal elements 2 can be covered with a layer of electrical insulant at their surface by varnishing or by oxidation. The body 1 is pierced by an axial hole 3 perpendicularly to the plane of the sheet-metal elements 2, as well as by a set of fixing holes 23 centered on a circle with the axis 4 as center. The axial through-hole 3 and the fixing holes 23 allow the rotor to be mounted and fixed onto a rotating shaft 102 of the device, as can be seen in FIG. 8.

The body 1 is bounded in the direction parallel to the geometric axis 4 by two opposite flat faces 5. The body 1 comprises a central part 6 of substantially cylindrical shape with circular cross section and with the axis 4 as geometric axis, and a plurality of teeth 7. The teeth 7, of substantially rectangular parallelepipedal shape, extend from the central part 6 radially with respect to the axis 4, their longer sides being parallel to the radial direction, and are spaced at regular angles. The teeth 7 are intended to participate in the variable-reluctance motor function of the device on which the rotor according to the invention is mounted. The end cross section 9 of the said teeth 7 is a rectangle the two sides of which are of similar lengths, these lengths corresponding approximately to the diameter of the radial inductors 110 of the variable-reluctance motor, which are visible in FIG. 8.

In accordance with the invention, the rotor also includes pins 8, made of a ferromagnetic material, which perform the function of magnetic bridges. They are intended to participate in the function of eddy-current braking of the device on which the rotor according to the invention is mounted. They are advantageously produced from a magnetic material without remanent magnetization, so as not to generate any residual torque when the braking coil is no longer fed with current. The pins 8 are, for example, of cylindrical shape with circular cross section, or of any other geometric shape representing the solid part of the rotor. They are housed in through-holes pierced into the body 1 parallel to the axis 4 and extend from one to the other of the said two opposite flat faces 5. The pins 8 carry out the double function of magnetic bridges and of reinforcements of the laminated structure of the rotor.

The pins 8 may be made of steel and are, preferably, covered by an electrically insulating layer, for example by oxidation or by varnishing, at the surface of their central part, in such a way as to be electrically insulated from the metal plates of the body 1. As can be seen in FIG. 3, the pins 8 have their two ends 21 welded to the body 1 level with the surfaces 5. Thus, the pins 8 also hold the sheet-metal elements 2 of the laminated material in contact against one another, counter to the electromagnetic forces which tend to separate the said sheet-metal elements 2 of the laminated rotor in the course of the operation of the variable-reluctance motor. The electrical insulation between the pins 8 and the body 1 is, obviously, not effective at the weld points on the surfaces 5.

In a first variant of the invention, represented in FIG. 1, the pins 8 are arranged through the teeth 7, each tooth 7 including a tooth pin 8 centered, for example, at mid-length of the median radial axis of the said tooth 7. In a second variant of the invention, represented in FIG. 2, each tooth 7 includes two tooth pins 8 radially spaced on the median radial axis of the said tooth 7. In another variant of the invention, all or some of the pins 8 may have a cross section other than circular, either elliptical or polygonal. It is also possible to provide for these pins 8 to be lodged in a groove formed at the periphery of the teeth 7.

In one particular embodiment of the invention, represented in FIG. 7, the teeth 7 are linked together by median webs 10 in the shape of angular sectors of lesser thickness than the body 1. The median webs 10 are formed by a part of the stack of sheet-metal elements 2 of the body 1, in which part the elements 2 are cut out according to a different profile than the elements 2 forming the ends of the stack, in such a way that the notches separating the teeth 7 are shallower there. The median webs 10 increase the passage cross sections for the magnetic flux in variable-reluctance motor operation. Furthermore, the median webs 10 improve the rigidity of the rotor and thus its mechanical strength.

A further subject of the invention is a device having an eddy-current brake function and a variable-reluctance motor function, which will now be described by reference to FIG. 8.

The device according to the invention includes a casing 101 the side walls 110a of which are in the shape of a circular disk pierced at its center and the longitudinal wall 110b of which is of circular cylindrical shape. The rotating shaft 102 is mounted, by way of bearings 103, through the side walls 110a of the casing 101. The shaft 102 is intended to be coupled to the object the movement of which is to be driven and/or braked by the device according to the invention. The shaft 102 rotates as one with a laminated rotor 112, as described in any one of the variants above, which extends within the casing 101. The rotor 112 is represented as a solid body in FIG. 8 so as not to overload the figure. A stator made of ferromagnetic material 108 surrounds the rotor 112 over its entire periphery.

Close to their periphery, the walls 110a include an annular recess 114a, on their inner face, intended to accommodate, successively in a radial direction, an annular retaining piece 115, an induction coil 105 and the longitudinal wall 101b of the casing 101. The circular induction coil 105 is carried by the inner periphery of the longitudinal cylindrical wall 10b of the casing 101 over its entire length, in order to generate an axial magnetic field. The retaining piece 115 consists of a hollow cylindrical sleeve intended to hold the stator 108 laterally at the center of the casing 101. The induction coil 105 extends from the cylindrical wall 101b and surrounds both the stator 108 and the retaining pieces 115.

The stator 108 is interposed radially between the rotor 112 and the coil 105. It includes, on its inner periphery, substantially rectangular notches in which are housed excitation coils 110 the axes of which extend radially with respect to the axis 4 of the rotor 112. The notches formed on the inner periphery of the stator 108 define a toothed stator. In a way similar to the rotor 112, in order to reduce the losses by eddy currents in it, the stator 108 includes a stack of ferromagnetic metal plates which are coaxial and orthogonal to the axis 4.

The side walls 110a of the casing 101 include an annular collar 114 projecting axially inward, so as to define a bearing surface for heat exchangers 106, carried in projection by the two inner faces of the side walls 110a of the casing 101. The heat exchangers 106 include circulation chambers for cooling liquid, for example water. The heat exchangers 106 are axially spaced from the rotor 112 by a slight clearance forming a gap of small dimensions. The annular cooling chambers 106 extend radially beyond the shaft 102 and face-to-face with the rotor 112, especially facing the various pins 8 of the rotor 112. If appropriate, the outer diameter of the heat exchangers 106 is preferably substantially equal to the outer diameter of the webs 10 of the rotor 112. The stator 108 substantially surrounds the heat exchangers 106 and the rotor 112.

The pins 8 enhance the effectiveness of the laminated rotor according to the invention for the function of eddy-current braking of the device by comparison with a conventional laminated rotor. This is because, when it is used in braking mode, the rotor is immersed in the magnetic field oriented parallel to the axis 4 produced by the induction coil 105, in such a way as to induce eddy currents. The pins 8, being ferromagnetic and parallel to the axis of this magnetic field, concentrate the field lines. They increase the induction which is therefore a maximum facing a pin 8 and a minimum between two teeth 7. They thus increase the flux which passes through the tooth 7, because they make it possible to establish a continuous magnetic induction field over the entire thickness of the rotor, in contrast to the laminated material, in which the interfaces between sheet-metal elements 2 generate discontinuities of the magnetic field. They contribute indirectly to increasing the currents induced on the surface of the exchangers 106 face-to-face with the rotor.

The performance of a device including a laminated rotor according to the invention will now be described, by reference to FIGS. 4 to 6. FIGS. 4 to 6 represent results of comparative tests in braking mode between a laminated rotor with magnetic bridges according to the invention and a solid rotor. In FIG. 4, measurements, taken on a test bench, of the braking torque C supplied by the same eddy-current braking device are plotted as a function of the speed of rotation Ù of the rotor for different values of the current strength in the induction coils. The curves 11 and 12 represent the results obtained with the solid rotor made of 25CD4 steel alloy. The curves 13 and 14 represent the results obtained with the rotor according to the invention, made of iron alloy with 3% of silicon, laminated with insulated laminations of 0.5 mm thickness. The power-supply current strength is 1 A in the case of curves 11 and 13, and 2 A in the case of curves 12 and 14. The comparison of the curves 11 and 13, on the one hand, and of the curves 12 and 14, on the other hand, makes it possible to conclude that the use of the rotor made of laminated material according to the invention leads to a loss of effectiveness of only 20 to 25% by comparison with the solid, metal-alloy rotor. The curve 15 of FIG. 4 represents the results obtained via a simulation calculation for the solid rotor. The good agreement of this calculation result with the experimental result represented by the curve 12 shows the validity of the model used for the calculation. The curve 16 of FIG. 4 represents the results obtained via a simulation calculation with the same model for a solid rotor made of a ferromagnetic material with relative magnetic permittivity \grave{ir} equal to 110. The relatively good agreement between the curves 16 and 14 indicates that the laminated rotor according to the invention is equivalent, as far as the braking torque is concerned, to a solid rotor produced from such a material.

FIG. 5 represents results of digital simulation of the braking torque C and of the dissipated power P of an eddy-current braking device as a function of the rotational speed Ù for the two types of rotor, and with the same power-supply current strength of 10 A. The curves 17 and 18 represent the torque C obtained with the solid rotor made of 25CD4 steel alloy and the solid rotor equivalent to the rotor according to the invention respectively. The curves 19 and 20 represent the power P obtained with the solid rotor made of 25CD4 steel alloy and the solid rotor equivalent to the rotor according to the invention respectively. This figure also shows that the maximum torque and the maximum braking power furnished by the device are reduced by only 25% when a laminated rotor according to the invention is used instead of a solid rotor. This loss of effectiveness can be compensated for by increasing the amplitude of the magnetic braking field.

The values represented by the curves 17 to 20 of FIG. 5 are obtained with a current strength of 10 A. For a given rotational speed Ω, this power-supply current strength has to be increased to 15.5 A with the rotor according to the invention in order to obtain a braking torque equal to that obtained [lacuna] the solid rotor at 10 A. The equivalence between the use of the solid rotor with a power-supply current strength of 10 A and the use of the rotor according to the invention with a power-supply current strength of 15.5 A is illustrated in FIG. 6, in which are represented the same magnitudes as in FIG. 5 with the same reference numerals, in extrapolation for a braking device with maximum power P equal to 220 kW.

Although the invention has been described in connection with several particular embodiment variants, it is quite obvious that it is not in any way limited to those, and that it comprises all the technical equivalents of the means described as well as their combinations, if they fall within the scope of the invention.

1. Laminated rotor for an eddy-current braking device including a stack (1) of flat elements (2) parallel to each other, made of ferromagnetic material, the said stack being bounded in the direction perpendicular to the said flat elements (2) by two opposite surfaces (5), at least one housing through the thickness of the said stack for accommodating a ferromagnetic component (8), made of ferromagnetic material which is solid or laminated in another direction than the said stack (1), able to establish a magnetic bridge extending between the said two opposite surfaces (5) and/or to hold the said flat elements assembled, characterized in that it is also able to serve as rotor of a variable-reluctance motor, the said stack (1) comprising a plurality of teeth (7) cut out in the said flat elements (2) and extending substantially radially with respect to the said axis of rotation (4, 102) from a substantially cylindrical central part (6).

2. Rotor according to claim 1, characterized in that each ferromagnetic component (8) includes two ends linked respectively to each of the said two opposite surfaces (5), in such a way as to keep the said flat elements (2) in contact against one another.

3. Rotor according to claim 2, characterized in that each ferromagnetic component (8) is electrically insulated from the said stack (1), except possibly in the vicinity of the said two linked ends.

4. Rotor according to one of claims 1 to 3, characterized in that each ferromagnetic component includes a pin (8), of any shape, extending through the said flat elements (2) substantially perpendicularly to them.

5. Rotor according to claim 4, characterized in that each pin (8) is welded at its ends (21) to the said two opposite surfaces (5).

6. Rotor according to one of claims 4 and 5, characterized in that the said stack (1) comprises a central part (6) in which an axial hole (3) is pierced, substantially perpendicularly to the said flat elements (2), in order to allow the said rotor to be mounted on an axis of rotation (4, 102).

7. Rotor according to claim 1, characterized in that the majority of the teeth (7) each include at least one of the said pins (8).

8. Rotor according to claim 7, characterized in that each tooth (7) includes several of the said pins (8) radially spaced from one another.

9. Rotor according to claim 7 or 8, characterized in that each pin (8) is arranged on a median radial axis of the associated tooth.

10. Rotor according to one of claims 1 to 9, characterized in that at least one first sub-set of the said stack (1) includes the said teeth (7) cut out over a first predetermined radial distance from the periphery of the flat elements (2), and at least one second sub-set of the said stack (1) includes the said teeth (7) cut out over a second predetermined radial distance greater than the said first radial distance, in such a way that the said first sub-set defines a plurality of webs (10) between the teeth (7) of the second sub-set.

11. Rotor according to claim 10, characterized in that the said first sub-set is in the middle of the stack (1) and includes, on either side of its median plane, a sub-set of the type of the above-mentioned second sub-set.

12. Rotor according to one of claims 1 to 11, characterized in that each flat element (2) is covered on its two opposite flat faces by a layer of electrical insulant.

13. Eddy-current braking device, characterized in that it comprises a laminated rotor (112) according to any one of the preceding claims, integral with a shaft (102) mounted rotating through a casing (101) containing at least one induction coil (105) carried by an inner peripheral region of the said casing (101), in order to generate a magnetic field through the said rotor, the said field being able to generate eddy currents so as to brake the rotation of the shaft (102).

14. Device according to claim 13, characterized in that it further includes a plurality of induction coils (110) with substantially radial axes and spaced at angles over the inner periphery of the casing (101), the said radial coils (110) being able to be fed sequentially so as to drive the teeth (7) of the rotor in rotation by the action of a substantially radial magnetic field of variable angular direction, so that the device can also serve as a variable-reluctance motor.

15. Device according to claim 13 or 14, characterized in that the casing (101) includes heat exchangers (106) axially spaced from the opposite surfaces (5) of the rotor (112) by a gap, in such a way that the said ferromagnetic components (8) serving as magnetic bridges are positioned face-to-face with the said heat exchangers (106).
